(19) United States
(12) Patent Application Publication
(10) Pub. No.: US 2024/0409052 A1
(43) Pub. Date: Dec. 12, 2024

(54) UTILITY VEHICLE, TRAILER, AND CARGO BED COVER STRUCTURE

(71) Applicant: KAWASAKI MOTORS, LTD., Akashi-Shi (JP)

(72) Inventors: Nobuyuki NISHIGUCHI, Akashi-Shi (JP); Norikazu MATSUMURA, Akashi-Shi (JP); Shogo SAKAGUCHI, Akashi-Shi (JP); Teruaki YAMAMOTO, Akashi-Shi (JP); Shuichi MIYANISHI, Akashi-Shi (JP); Tokishin NISHINAKA, Akashi-Shi (JP)

(73) Assignee: KAWASAKI MOTORS, LTD., Akashi-Shi (JP)

(21) Appl. No.: 18/329,692

(22) Filed: Jun. 6, 2023

(51) Int. Cl. B60R 21/13; B62D 33/02; B62D 33/08

(52) U.S. Cl. CPC B60R 21/13; B62D 33/02; B62D 33/08

(57) ABSTRACT

A utility vehicle includes: a rollover protective structure (ROPS) that defines a riding space; a cargo bed that is located rearward of the ROPS; and a support frame to support a cargo bed cover that covers the cargo bed.

### BACKGROUND OF THE INVENTION

### Field of the Invention

The present disclosure relates to utility vehicles, trailers, and cargo bed cover structures.

### Description of the Background Art

US 2018/0186330 A1 discloses a utility vehicle including a rollover protective structure (ROPS) that defines a riding space and a cargo bed that is located rearward of the ROPS.

### SUMMARY

A utility vehicle includes: a rollover protective structure (ROPS) that defines a riding space; a cargo bed that is located rearward of the ROPS; and a support frame to support a cargo bed cover that covers the cargo bed.

According to the utility vehicle, the cargo bed cover is easily attachable.

These and other objects, features, aspects and advantages of the present disclosure will become more apparent from the following detailed description when taken in conjunction with the accompanying drawings.

### BRIEF DESCRIPTION OF THE DRAWINGS

FIG. 1 is a side view illustrating a utility vehicle.

FIG. 2 is a perspective view illustrating a cargo bed, support frames, and a cargo bed cover.

FIG. 3 is a side view illustrating the utility vehicle dumping the cargo bed.

FIG. 4 is a perspective view illustrating the cargo bed and the support frames.

FIG. 5 is a rear view illustrating the support frames being attached to the cargo bed.

FIG. 6 is a side view illustrating a utility vehicle including a lock.

FIG. 7 is a cross-sectional view taken along the line VII-VII in FIG. 6.

FIG. 8 is a perspective view illustrating side flap covers.

FIG. 9 is a cross-sectional view taken along the line IX-IX in FIG. 8.

FIG. 10 is a perspective view illustrating a rear flap cover.

FIG. 11 is a perspective view illustrating rear flap covers.

FIG. 12 is a side view illustrating a cargo bed cover with a window.

FIG. 13 is a perspective view illustrating the cargo bed cover being attached and removed.

FIG. 14 is a cross-sectional view illustrating the cargo bed cover being opened and closed.

FIG. 15 is a side view illustrating the cargo bed cover being opened and closed.

FIG. 16 is a rear view illustrating a cargo bed cover being opened and closed.

FIG. 17 is a side view illustrating the utility vehicle and a trailer.

FIG. 18 is a side view illustrating the cargo bed.

### DESCRIPTION OF THE PREFERRED EMBODIMENTS

### Embodiment

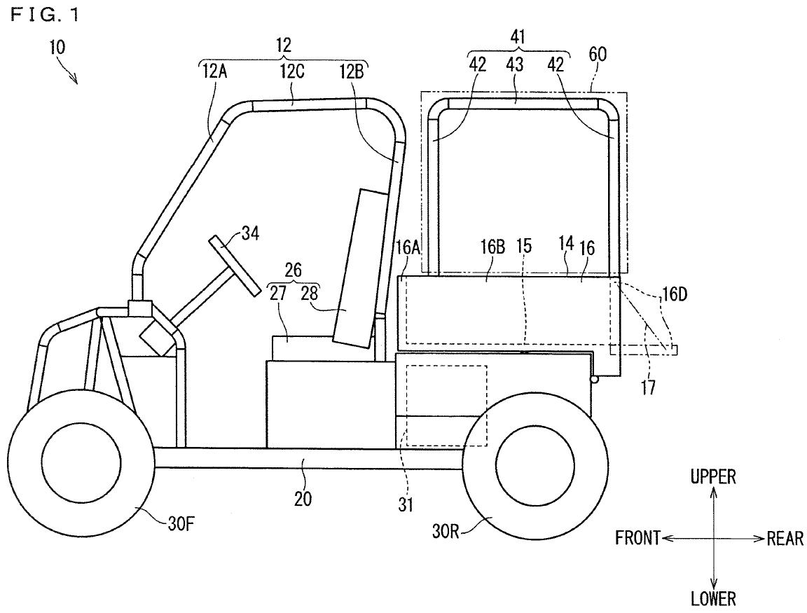

A utility vehicle according to an embodiment will be described below. FIG. 1 is a side view illustrating a utility vehicle 10. In description made below, a direction of travel of the utility vehicle 10 is also referred to as a forward direction, a direction opposite the forward direction is also referred to as a rearward direction, a direction toward a road surface on which the utility vehicle 10 travels is also referred to as a downward direction, and a direction opposite the downward direction is also referred to as an upward direction. Left and right are sometimes referred to in a state of facing forward while standing on the road surface. A left-right direction is a vehicle width direction.

### <Overall Configuration of Utility Vehicle>

The utility vehicle 10 includes a rollover protective structure (ROPS) 12, a cargo bed 14, a chassis 20, support frames 41, and a cargo bed cover 60. In the present embodiment, the utility vehicle 10 further includes a seat 26, a travel mechanism, and a driving operation mechanism.

The ROPS 12 defines a riding space. In an example illustrated in FIG. 1, the ROPS 12 includes vertical frames 12A, vertical frames 12B, and horizontal frames 12C. The vertical frames 12A and the vertical frames 12B are away from each other in a front-rear direction. The seat 26, a steering wheel 34, and the like are located between the vertical frames 12A and the vertical frames 12B in the front-rear direction. The horizontal frames 12C connect upper ends of the vertical frames 12A and the vertical frames 12B. The vertical frames 12A, the vertical frames 12B, and the horizontal frames 12C are provided on left and right sides to form a pair. The seat 26, the steering wheel 34, and the like are located between the frames 12A, 12B, and 12C forming the pair in the left-right direction. The ROPS 12 may include a cross frame that connects the horizontal frames 12C provided on the left and right sides to form a pair.

The cargo bed 14 is located rearward of the ROPS 12. In the example illustrated in FIG. 1, the cargo bed 14 includes a mount 15 and a peripheral wall 16 that surrounds a periphery of the mount 15. A wall as a portion of the peripheral wall 16 may be openable and closable around an axis extending along an outer edge of the mount 15 at the bottom of the wall. In the example illustrated in FIG. 1, a rear wall 16D is openable and closable around an axis along the left-right direction at the bottom of the rear wall 16D. In this case, a rear wall support 17 that supports the opening rear wall 16D may be provided to the cargo bed 14 as illustrated in FIG. 1.

The chassis 20 supports the cargo bed 14. Parts (e.g., the seat 26, the ROPS 12, a travel motor 31, and wheels 30F and 30R) of the utility vehicle 10 other than the cargo bed 14 are also supported by the chassis 20.

The support frames 41 are members to support the cargo bed cover 60 that covers the cargo bed 14. The cargo bed cover 60 is supported by the support frames 41. The support frames 41 and the cargo bed cover 60 will be described in detail below.

The seat 26 includes a seat cushion 27 an occupant is seated on and a seat back 28 the occupant leans against. The seat back 28 has a height enabling support of the back of the occupant seated on the seat 26. In the example illustrated in FIG. 1, only one seat 26 in the front-rear direction is provided. Two seats 26 and three or more seats 26 may be provided separately in the front-rear direction.

The travel mechanism is a mechanism for travel of the utility vehicle 10 and includes the wheels 30F and 30R, the travel motor 31, and a power transmission mechanism. Rotational driving force of the travel motor 31 is transmitted to the wheels 30F and 30R via the power transmission mechanism to cause the utility vehicle 10 to travel. An example in which the utility vehicle 10 includes four wheels 30F and 30R is described in the present embodiment. The utility vehicle 10 may include three wheels and may include six wheels. The power transmission mechanism may have any configuration, and the power transmission mechanism may include a transmission and a drive shaft, for example.

The wheels 30F and 30R include front wheels 30F and rear wheels 30R. Two front wheels 30F are supported to be rotatable around a central axis thereof and to be rotatable around a steering axis on left and right sides of the front of the chassis 20. Two rear wheels 30R are supported to be rotatable around a central axis thereof on left and right sides of the rear of the chassis 20.

The travel motor 31 may be an electric motor that converts electric energy into rotational motion for travel. In this case, the utility vehicle 10 includes a travel battery that supplies electric energy to the travel motor 31. The travel motor 31 may be an internal combustion engine that combusts fuel in a combustion chamber and expands gas by combustion to generate power for travel. In this case, the utility vehicle 10 is required to include a fuel tank. The travel motor 31 may be provided at any position. For example, the travel motor 31 is supported at the bottom of the cargo bed 14.

The driving operation mechanism is a mechanism to receive driving operation of a driver and includes the steering wheel 34 and an unillustrated pedal, for example. The driver can rotate the front wheels 30F around the steering axis by operating the steering wheel 34. The driver can perform accelerator operation and brake operation by operating the pedal. The steering wheel 34 and the pedal are located forward of the seat 26. The driver seated on the seat 26 can operate the steering wheel 34 and the pedal. For example, the steering wheel 34 protrudes rearward of lower ends of the vertical frames 12A. The pedal is located below the steering wheel 34. The pedal may include an accelerator pedal and a brake pedal provided separately, or a single pedal may be provided so that both an accelerator and a brake are operable.

There are openings between the frames 12A, 12B, and 12C of the ROPS 12. For example, openings outward of left and right sides of the seat 26 are openings for entry and exit of the occupant to and from the utility vehicle 10. The utility vehicle 10 can normally travel with the openings being open without being completely blocked by a door and the like. The openings between the frames 12A, 12B, and 12C of the ROPS 12 of the utility vehicle 10 may be blocked by a cover and the like as appropriate.

A cover provided to the ROPS 12 and blocking an opening forward of the seat 26 can be considered as a windshield. A cover provided to the ROPS 12 and blocking an opening upward of the seat 26 can be considered as a roof. A cover provided to the ROPS 12 and blocking an opening on a side of the seat 26 can be considered as a door. A cover provided to the ROPS 12 and blocking an opening rearward of the seat 26 can be considered as a rear partition wall. One or more of the windshield, the roof, the door, and the rear partition wall may be provided as covers provided to the ROPS 12. In a case where two or more of the windshield, the roof, the door, and the rear partition wall are provided as the covers, they may separately be provided or may integrally be provided.

### <Cargo Bed, Support Frames, and Cargo Bed Cover>

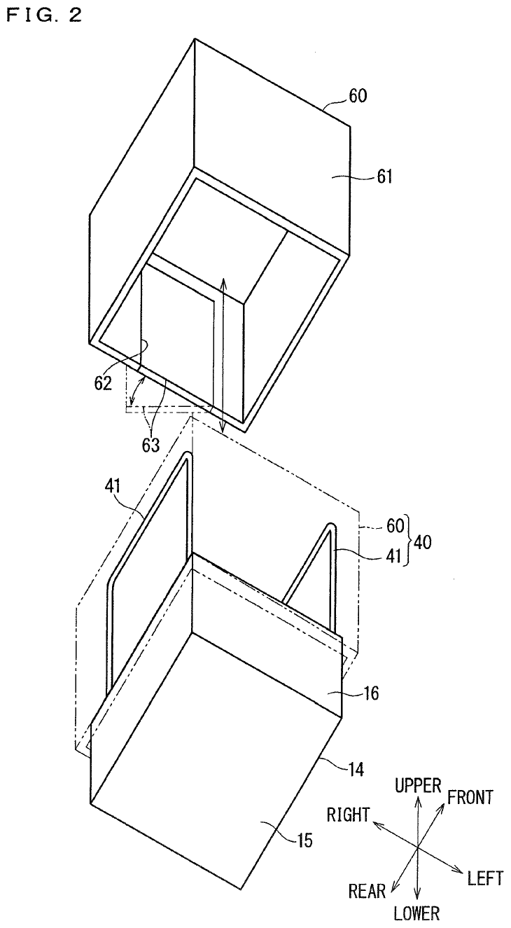

FIG. 2 is a perspective view illustrating the cargo bed 14, the support frames 41, and the cargo bed cover 60.

In an example illustrated in FIG. 2, the support frames 41 are provided to the cargo bed 14. The peripheral wall 16 of the cargo bed 14 includes a front wall 16A, a left wall 16B, a right wall 16C, and the rear wall 16D. The support frames 41 may be provided on a vehicle body other than the cargo bed 14, such as the chassis 20.

In the example illustrated in FIG. 2, the support frames 41 each include vertically extending support columns 42 and a horizontally extending beam 43. Four support columns 42 are arranged separately in the left-right direction and the front-rear direction on the cargo bed 14. The beam 43 connects upper ends of two support columns 42 arranged separately in the front-rear direction on each of left and right sides of the cargo bed 14. The support frames 41 may each include a beam connecting upper ends of two support columns 42 arranged separately in the left-right direction on each of front and rear sides of the cargo bed 14. The support frames 41 may include both the beam 43 extending in the front-rear direction and the beam extending in the left-right direction. The support frames 41 provided on the left and right sides to form a pair may each be formed by bending a rod-like member, such as a pipe. The rod-like member may have equivalent stiffness to the ROPS 12 or may have lower stiffness than the ROPS 12.

The purpose of the cargo bed cover 60 is not particularly limited and can be set as appropriate. For example, the purpose of the cargo bed cover 60 may be protection of cargo on the cargo bed 14 against water, wind, or falling. In a case where the purpose is protection against water, the cargo bed cover 60 is waterproof. Waterproof performance can be any waterproof performance ranging from waterproof performance enabling suppression of splashing to waterproof performance enabling complete waterproofness. In a case where the purpose is not protection against water, the cargo bed cover 60 is not required to be waterproof. For example, in a case where the purpose is protection against falling, the cargo bed cover 60 may be a perforated plate material, a net, and the like.

A member forming the cargo bed cover 60 is not particularly limited and can be set as appropriate. For example, the cargo bed cover 60 may be formed of an easily-deformed soft member, such as cloth. Alternatively, the cargo bed cover 60 may be formed of a difficult-to-deform rigid body, such as a metal plate and a resin plate having high stiffness, for example. The cargo bed cover 60 may be a composite cover obtained by combining the easily-deformed soft member and the difficult-to-deform rigid body, for example.

A range of the cargo bed 14 covered with the cargo bed cover 60 is not particularly limited and can be set as appropriate. In the example illustrated in FIG. 2, the cargo bed cover 60 covers all the front, the left side, the right side, the rear, and the top of the cargo bed 14. The cargo bed cover 60 is not required to cover all the front, the left side, the right side, the rear, and the top of the cargo bed 14 and is only required to cover a portion of the cargo bed 14. In a case where the cargo bed cover 60 covers a periphery of the cargo bed 14, a lower end of the cargo bed cover 60 may or may not reach the cargo bed 14.

The range of the cargo bed 14 covered with the cargo bed cover 60 may be unchangeable from a predetermined range. The range of the cargo bed 14 covered with the cargo bed cover 60 may be changeable. In a case where the cargo bed cover 60 is the easily-deformed soft member, the range of the cargo bed 14 covered with the cargo bed cover 60 can be changeable by deformation of the cargo bed cover 60. In a case where the cargo bed cover 60 is the difficult-to-deform rigid body, the range of the cargo bed 14 covered with the cargo bed cover 60 can be changeable by a change in orientation of the cargo bed cover 60.

The cargo bed cover 60 includes a cover main body 61 that includes an opening 62 and a door 63 that blocks the opening 62 of the cover main body 61 so that the opening 62 is openable and closable. In the example illustrated in FIG. 2, the opening 62 and the door 63 are provided to a portion of the cover main body 61 that covers the rear of the cargo bed 14. The opening 62 and the door 63 may be provided to a portion of the cover main body 61 that covers a side or the front of the cargo bed 14.

A combination of the support frames 41 and the cargo bed cover 60 can be considered as a cargo bed cover structure 40 for the utility vehicle 10. The cargo bed cover structure 40 is the cargo bed cover structure 40 for the utility vehicle 10 including the ROPS 12 that defines the riding space and the cargo bed 14 that is located rearward of the ROPS 12 and includes the support frames 41 that are attachable to the utility vehicle 10 and the cargo bed cover 60 that is supported by the support frames 41 and covers the cargo bed 14.

### <Dumper>

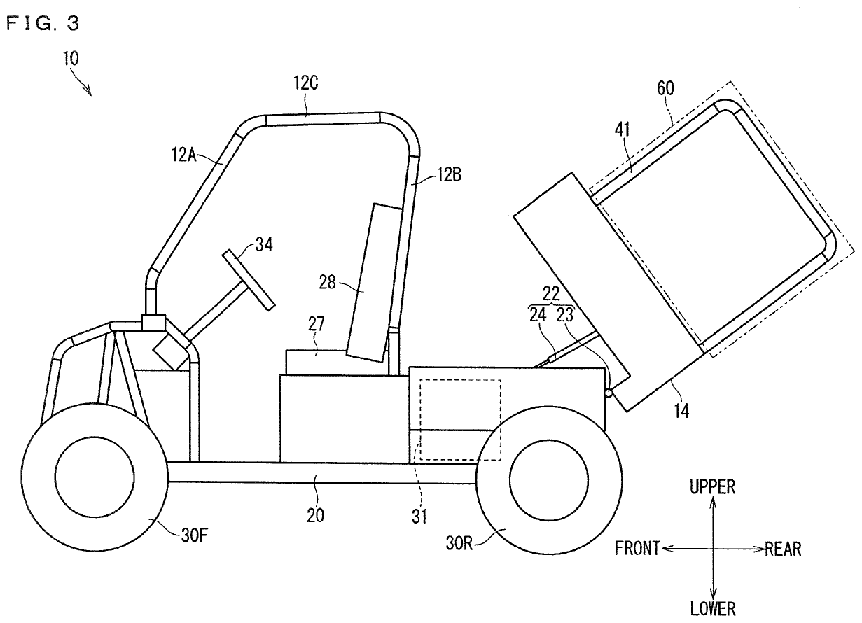

FIG. 3 is a side view illustrating the utility vehicle 10 dumping the cargo bed 14.

As illustrated in FIG. 3, the utility vehicle 10 may have a configuration in which the cargo bed 14 can be tilted. The utility vehicle 10 may have a configuration in which the cargo bed 14 cannot be tilted.

The utility vehicle 10 includes a dumper 22 to tilt the cargo bed 14. The dumper 22 can tilt the cargo bed 14 relative to the chassis 20. The dumper 22 includes a rotational shaft 23 that supports the cargo bed 14 so that the cargo bed 14 is rotatable relative to the chassis 20 and a cylinder 24 that imparts torque around the rotational shaft 23 to the cargo bed 14 at a position away from the rotational shaft 23. The rotational shaft 23 is provided at the bottom of the rear of the cargo bed 14. The cylinder 24 expands and contracts vertically. An upper end of the cylinder 24 is attached to the front of the cargo bed 14. The cylinder 24 lifts the front of the cargo bed 14. The cylinder 24 may be a power-operated cylinder and may be an air cylinder.

In a case where the utility vehicle 10 includes the dumper 22, the support frames 41 are preferably supported by the cargo bed 14. The support frames 41 can thus be moved together with the cargo bed 14. The support frames 41 and the cargo bed cover 60 tilted together with the cargo bed 14 are required not to interfere with a not-tilted vehicle body (e.g., the ROPS 12 and the roof) when the cargo bed 14 is tilted. For example, the not-tilted vehicle body (e.g., the ROPS 12 and the roof) may be provided not to be located on a rotational trajectory of the support frames 41 and the cargo bed cover 60 in advance. In a case where the not-tilted vehicle body (e.g., the ROPS 12 and the roof) are located on the rotational trajectory of the support frames 41 and the cargo bed cover 60, a portion of the not-tilted vehicle body located on the rotational trajectory of the support frames 41 and the cargo bed cover 60 may be formed to be retractable when the cargo bed 14 is tilted.

Even in a case where the utility vehicle 10 includes the dumper 22, the support frames 41 may be supported by a member other than the cargo bed 14. In this case, the cargo bed 14 is required not to interfere with the support frames 41 and the cargo bed cover 60 not tilted when the cargo bed 14 is tilted. For example, the support frames 41 and the cargo bed cover 60 not tilted may be provided not to be located on a rotational trajectory of the cargo bed 14 in advance. In a case where the support frames 41 and the cargo bed cover 60 not tilted are located on the rotational trajectory of the cargo bed 14, a portion of the support frames 41 and the cargo bed cover 60 not tilted located on the rotational trajectory of the cargo bed 14 may be formed to be retractable when the cargo bed 14 is tilted.

### <Support Frame Attachment Structure>

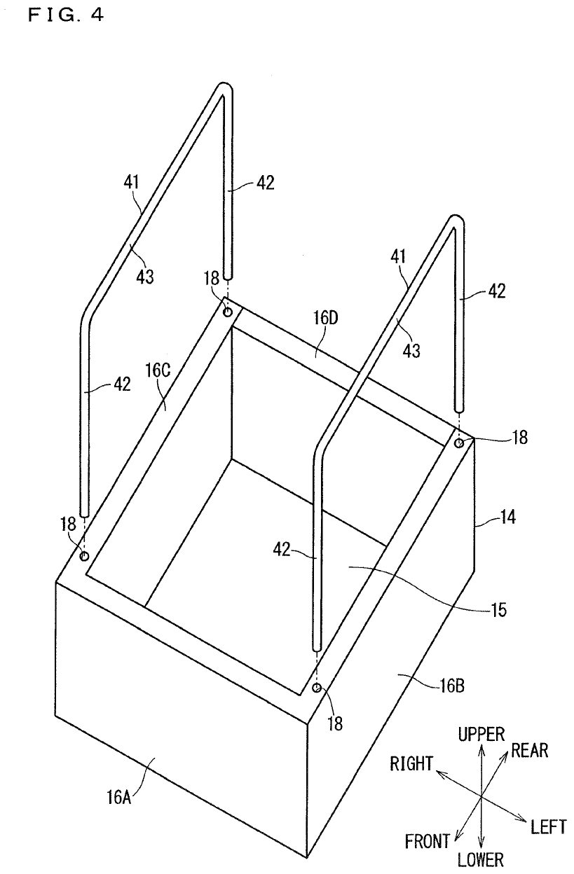

FIG. 4 is a perspective view illustrating the cargo bed 14 and the support frames 41.

In an example illustrated in FIG. 4, the support frames 41 are removably supported in the utility vehicle 10. In the example illustrated in FIG. 4, the support frames 41 are provided to the cargo bed 14.

The cargo bed 14 includes upward opening holes 18. In the example illustrated in FIG. 4, the holes 18 are formed in the peripheral wall 16. In the example illustrated in FIG. 4, the holes 18 are formed in the left wall 16B and the right wall 16C. The holes 18 may be formed in the mount 15 and may be formed in a wall as a portion of the peripheral wall 16 other than the left wall 16B and the right wall 16C. A lower end of each of the support columns 42 of the support frames 41 is inserted into a corresponding one of the holes 18 and supported.

A configuration in which the support frames 41 are removable is not limited to the above-mentioned configuration. For example, the lower end of each of the support columns 42 of the support frames 41 may be fastened to the peripheral wall 16 with a bolt and the like.

The support frames 41 are not necessarily required to be removably supported, and the support frames 41 may irremovably be provided.

### <Cover Support Displacement Structure>

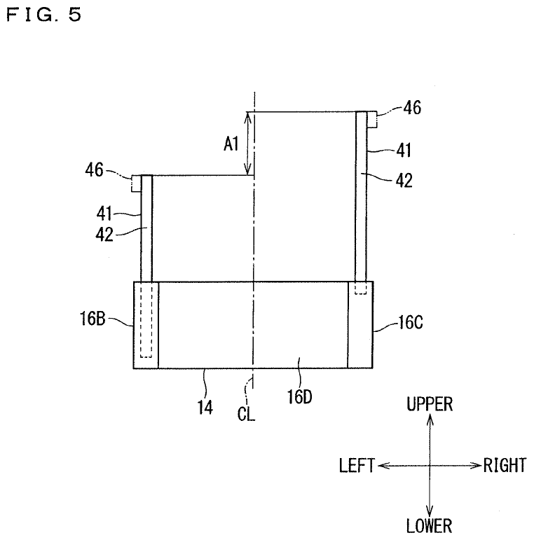

FIG. 5 is a rear view illustrating the support frames 41 being attached to the cargo bed 14.

The support frames 41 each include a cover support 46 that supports the cargo bed cover 60. The cover support 46 is vertically displaceable. For example, in a support structure using the support columns 42 and the holes 18 described above, the cover support 46 can be vertically displaceable when the amount of insertion of the support columns 42 into the holes 18 is changeable.

More specifically, in FIG. 5, a center line CL is a line passing through the center in a width direction of the utility vehicle 10. A support frame 41 to the left of the center line CL includes the support columns 42 being inserted into the holes 18 most deeply. A support frame 41 to the right of the center line CL includes the support columns 42 being inserted into the holes 18 most shallowly. An arrow A1 in FIG. 5 thus indicates a difference in amount of insertion between the support columns 42 on a left side and the support columns 42 on a right side. The position of the cover support 46 is changeable by an amount indicated by the arrow A1. While the cover support 46 is provided to the beam 43 in an example illustrated in FIG. 5, the cover support 46 may be provided to the support columns 42. In the example illustrated in FIG. 5, when leading ends of the support columns 42 are slid downward, the leading ends of the support columns 42 do not penetrate through the cargo bed 14 and are stored in the cargo bed 14. The leading ends of the support columns 42 may penetrate through the cargo bed 14 and protrude to a position below the cargo bed 14.

As in the example illustrated in FIG. 5, the cover support 46 can be vertically displaceable by vertically sliding each of the support frames 41. The cover support 46 may vertically be displaceable by causing each of the support frames 41 to have a link structure or a pin coupling structure to expand and contract or rotate. The support frames 41 may each include the cover support 46 displaceable in a direction different from the vertical direction (e.g., the front-rear direction and the vehicle width direction).

### <Lock>

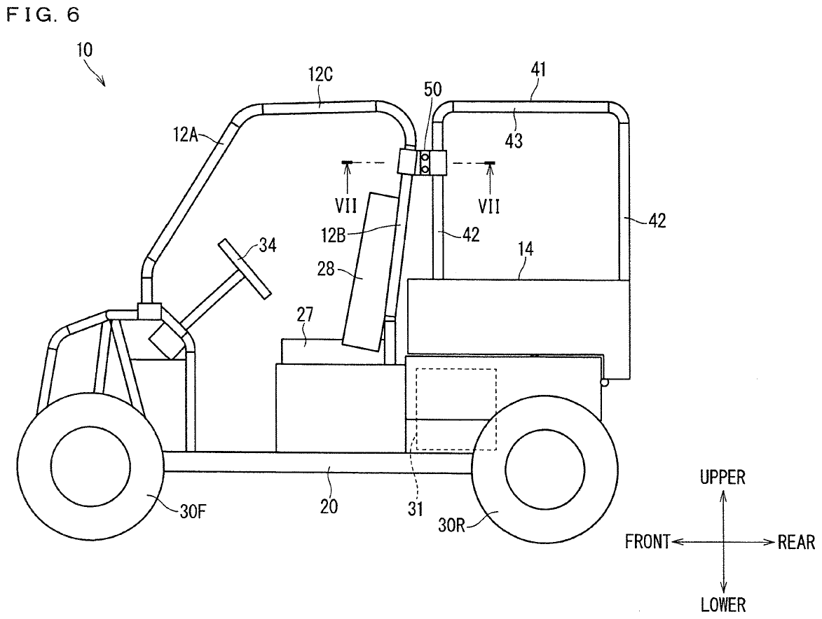

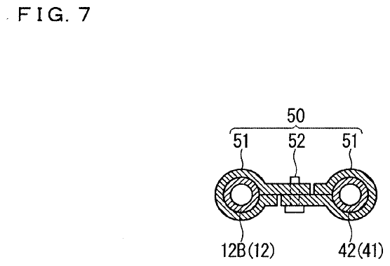

FIG. 6 is a side view illustrating the utility vehicle 10 including a lock 50. FIG. 7 is a cross-sectional view taken along the line VII-VII in FIG. 6.

The utility vehicle 10 includes the lock 50 that locks each of the support frames 41 to the ROPS 12. A configuration of the lock 50 is not particularly limited and can be set as appropriate. In an example illustrated in FIG. 7, the lock 50 includes connecting parts 51 that are externally mounted to the ROPS 12 and the support frame 41 and a screw 52 that fastens the connecting parts 51. A power-operable latch or a lock piece, such as a hook 78, may be provided in place of the screw 52.

The position at which the support frame 41 is locked to the ROPS 12 via the lock 50 is not particularly limited and can be set as appropriate. In the example illustrated in FIG. 6, the lock 50 locks the support frame 41 to a rear portion of the ROPS 12. The rear portion of the ROPS 12 may be at least any of a vertical frame on a side of the seat 26 or rearward of the seat 26 and a horizontal frame above the seat 26 or above and rearward of the seat 26, for example.

The lock 50 may be unlockable with respect to the ROPS 12 or the support frame 41. In the example illustrated in FIG. 7, the lock 50 is unlockable by removing the screw 52. The lock 50 may be not unlockable with respect to the ROPS 12 and the support frame 41.

In a case where the utility vehicle 10 includes the dumper 22, the utility vehicle 10 may include a configuration in which operation of the dumper 22 with the lock 50 performing locking is suppressed. For example, an actuator that performs operation to open and close the lock 50 may be used to perform operation to automatically open and close the lock 50 in conjunction with a switch for the dumper 22. Alternatively, a state of the lock 50 may be detected not to start the dumper 22 and to send a message indicating that the dumper 22 cannot be used in a case where the lock 50 performs locking, for example.

### <Side Flap Cover>

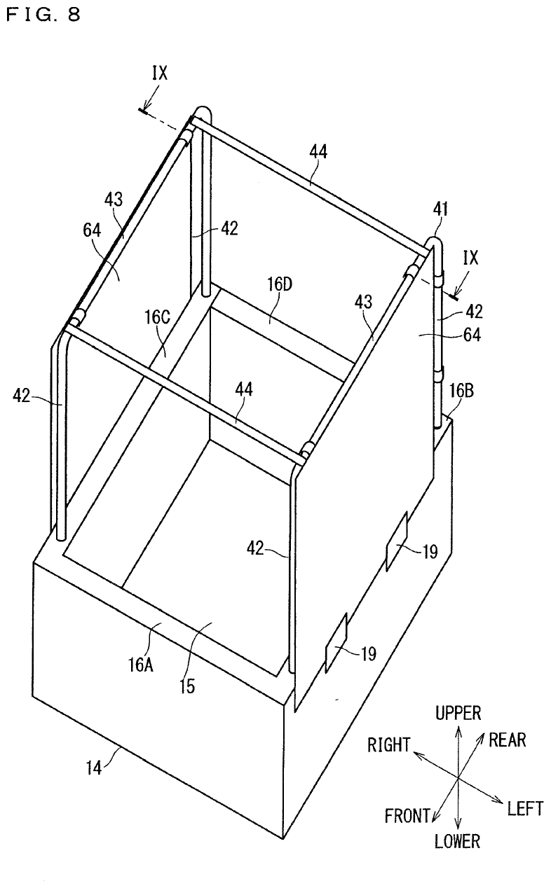

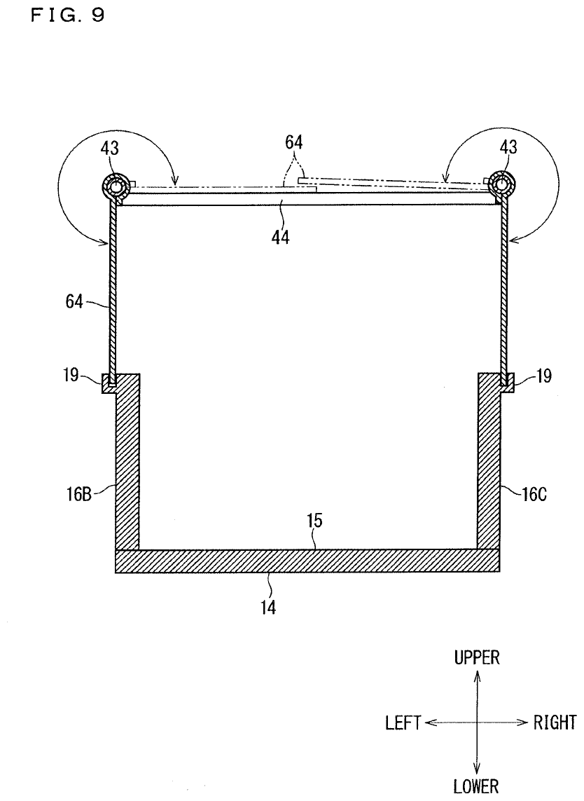

FIG. 8 is a perspective view illustrating side flap covers 64. FIG. 9 is a cross-sectional view taken along the line IX-IX in FIG. 8.

The cargo bed cover 60 includes one or more flap covers that are flappably supported by the support frames 41. Each flap cover is rotatable around a rotational axis. In an example illustrated in FIG. 8, the side flap covers 64 that are rotatable around axes along the front-rear direction are provided as the flap covers. The side flap covers 64 are each rotatably supported by the beam 43.

The support frames 41 include a first support that supports the side flap covers 64 in a first state in which sides of the cargo bed 14 are open and a second support that supports the side flap covers 64 in a second state in which the sides of the cargo bed 14 are covered. The first support supports the side flap covers 64 in a state in which the side flap covers 64 cover the top of the cargo bed 14. In an example illustrated in FIG. 9, a pair of beams 44 is provided separately from the beams 43. The paired beams 44 are provided separately in the front-rear direction. Each of the beams 44 extends in the left-right direction to connect the paired beams 43. The beams 44 are the first support. The second support is provided to the cargo bed 14 or the support columns 42. In the example illustrated in FIG. 9, the second support is hooks 19 that catch leading ends of the side flap covers 64 for support. The first support and the second support are not limited to those in these examples and can be set as appropriate. The first support may support the side flap covers 64 so that the leading ends of the side flap covers 64 are located outward below the first support.

In the example illustrated in FIG. 9, the side flap covers 64 are provided both on left and right sides. A side flap cover 64 may be provided on one of the left and right sides, and a fixed cover not flapping may be provided on the other one of the left and right sides.

In the example illustrated in FIG. 9, the side flap covers 64 on the left and right sides overlap at the center in the width direction of the utility vehicle 10 to cover the top of the cargo bed 14 across the entire width thereof. A single side flap cover 64 may be provided to cover the top of the cargo bed 14 across the entire width thereof.

### <Rear Flap Cover>

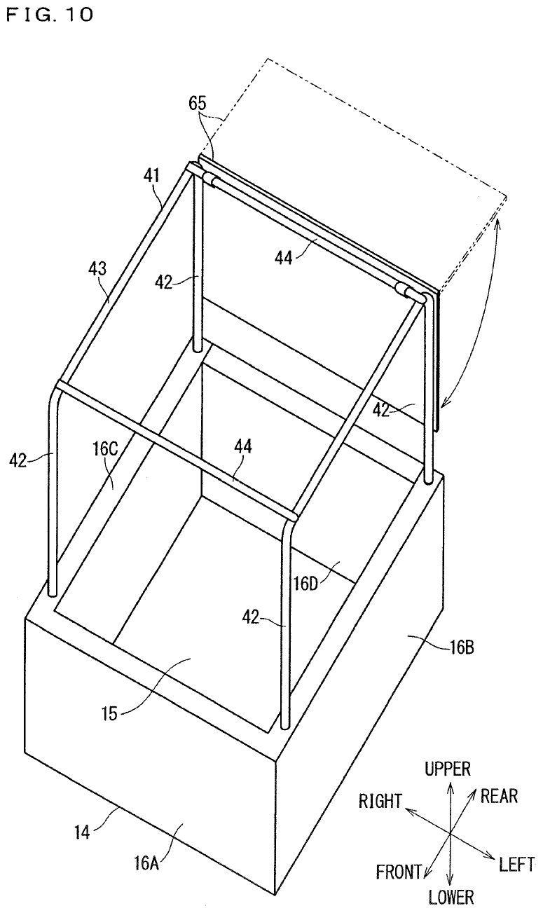

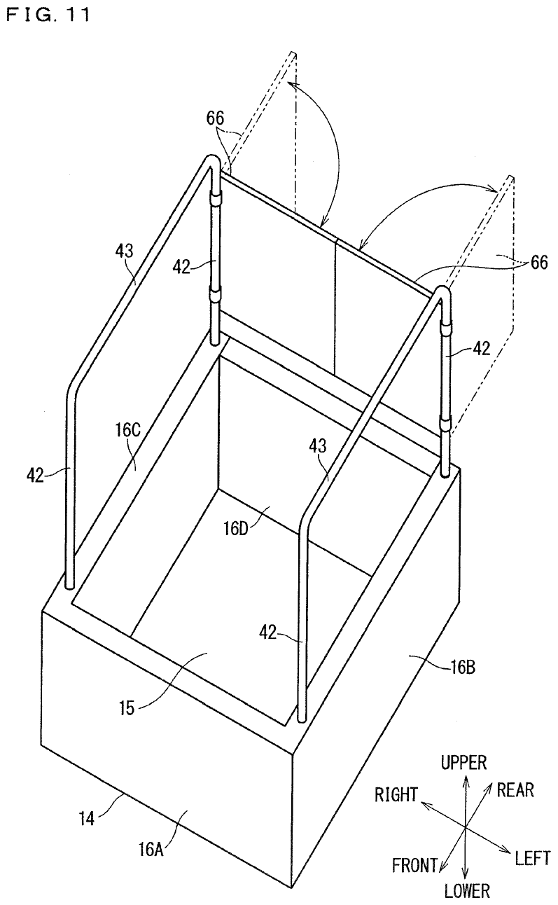

FIG. 10 is a perspective view illustrating a rear flap cover 65. FIG. 11 is a perspective view illustrating rear flap covers 66.

In an example illustrated in FIG. 10, the rear flap cover 65 that covers the rear of the cargo bed 14 and flaps around an axis along the vehicle width direction is provided as the flap cover. The rear flap cover 65 is rotatably supported by one of the beams 44. In the example illustrated in FIG. 10, a single rear flap cover 65 covers the rear. In a case of the example illustrated in FIG. 10, if the rear wall 16D is openable and closable, the rear flap cover 65 and the rear wall 16D are double doors arranged vertically.

In an example illustrated in FIG. 11, the rear flap covers 66 that cover the rear of the cargo bed 14 and flap around axes along the vertical direction are provided as the flap covers. The rear flap covers 66 are rotatably supported by the support columns 42. In the example illustrated in FIG. 11, two rear flap covers 66 cover the rear. As illustrated in FIG. 10, the number of rear flap covers 66 may be one.

The rear flap cover 65 or the rear flap covers 66 and the side flap covers 64 may be provided to a single cargo bed 14. That is to say, the flap covers may be provided on both the left and right sides and the rear of the cargo bed 14.

### <Window 68 of Cargo Bed Cover>

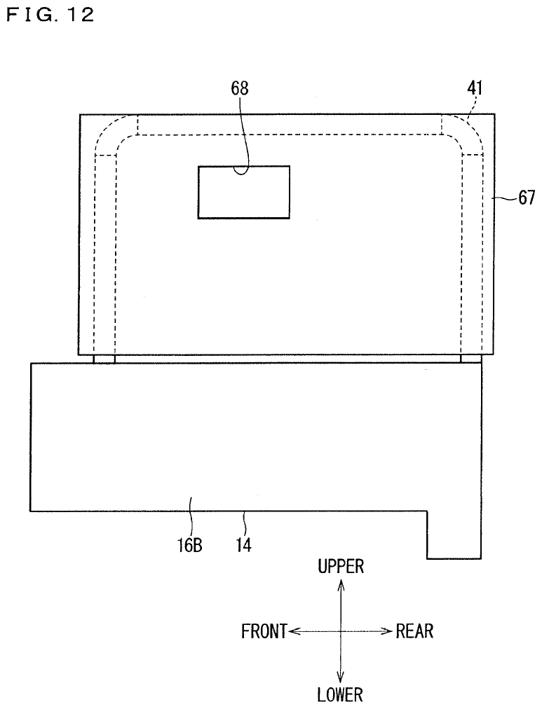

FIG. 12 is a side view illustrating a cargo bed cover with a window 68.

In an example illustrated in FIG. 12, a vertical cover 67 that covers a side or the rear of the cargo bed 14 is provided as the cargo bed cover. The vertical cover 67 includes a main surface that extends along the vertical direction. In the example illustrated in FIG. 12, the vertical cover 67 covers the side of the cargo bed 14. The vertical cover 67 may cover the front or the rear of the cargo bed 14.

The vertical cover 67 includes the window 68. The window 68 may include an opening of the vertical cover 67 that allows an outside and an inside of the vehicle body to communicate and a member that blocks the opening. The member that blocks the opening may be openable and closable. The window 68 may include only the opening of the vertical cover 67. An inside of the cargo bed cover 60 may be visible from outside the cargo bed cover 60 through the window 68. An object may be loadable to and unloadable from the inside of the cargo bed cover 60 from outside the cargo bed cover 60 through the window 68.

### <Attachment and Removal of Cargo Bed Cover>

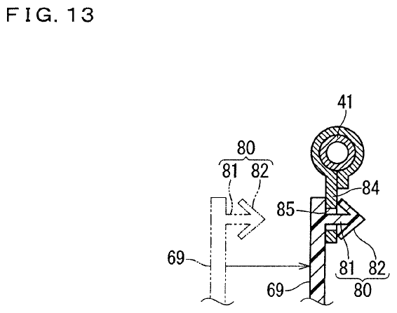

FIG. 13 is a perspective view illustrating a cargo bed cover 69 being attached and removed.

The cargo bed cover 69 is removably attachable to the support frames 41. In an example illustrated in FIG. 13, an attachment part 80 provided to the cargo bed cover 69 is removably attached to an attachment receiver 84 provided to the support frames 41.

The attachment part 80 is in the form of a clip including a column 81 protruding from the cargo bed cover 69 and a barb 82 provided to a leading end of the column 81. An attachment hole 85 is formed in the attachment receiver 84. The attachment part 80 is inserted into the attachment hole 85 and engaged. The attachment receiver 84 may be in the form of a clip, and the attachment hole 85 may be formed in the attachment part 80. The attachment part 80 and the attachment receiver 84 may be male and female snap fasteners.

### <Opening and Closing of Cargo Bed Cover>

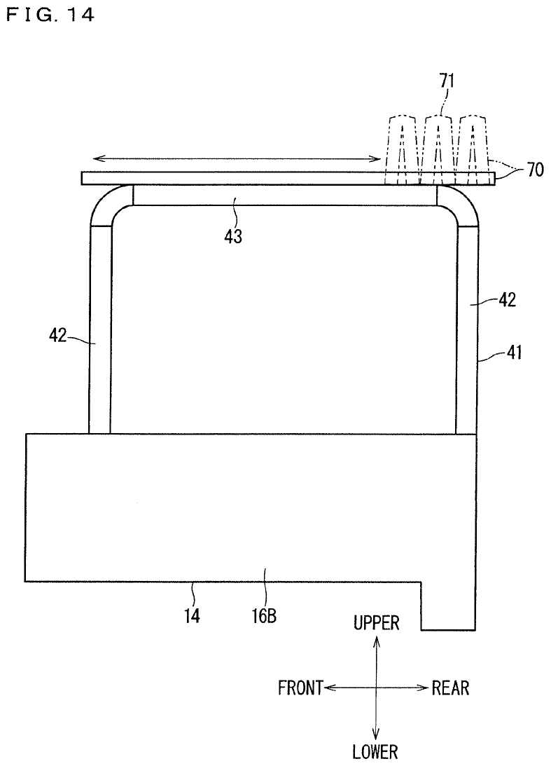

FIGS. 14, 15, and 16 are each a cross-sectional view illustrating the cargo bed cover being opened and closed.

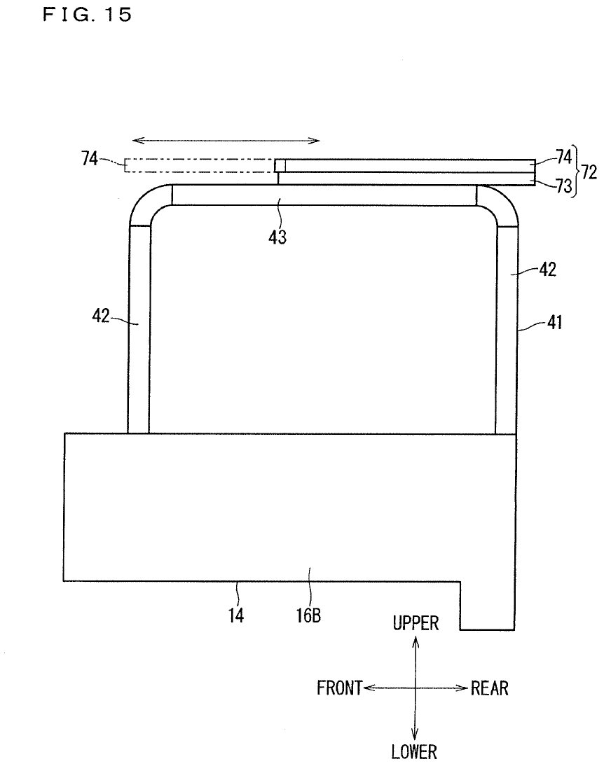

In examples illustrated in FIGS. 14 and 15, the cargo bed cover is changeable between a cover state in which the cargo bed cover covers the top of the cargo bed 14 and a top opening state in which the cargo bed cover covers a smaller range of the top of the cargo bed 14 than in the cover state while being attached to the support frames 41.

In an example illustrated in FIG. 14, an accordion cover 70 is provided as the cargo bed cover. The accordion cover 70 is changeable between a state indicated by an alternate long and two short dashes line and a state indicated by a solid line in FIG. 14. The state indicated by the alternate long and two short dashes line in FIG. 14 is a folded state to form a bellows 71. The folded state is the top opening state. The state indicated by the solid line in FIG. 14 is an unfolded state. The unfolded state is the cover state.

In an example illustrated in FIG. 15, a sliding cover 72 is provided as the cargo bed cover. The sliding cover 72 includes a first cover 73 and a second cover 74. At least one of the first cover 73 and the second cover 74 is slidably movable. The sliding cover 72 is changeable between a state indicated by a solid line and a state indicated by an alternate long and two short dashes line in FIG. 15. The state indicated by the solid line in FIG. 15 is a state in which a range of overlap between the first cover 73 and the second cover 74 is large, and this state is the top opening state. The state indicated by the alternate long and two short dashes line in FIG. 15 is a state in which the range of overlap between the first cover 73 and the second cover 74 is small, and this state is the cover state. In the example illustrated in FIG. 15, an example of a single sliding cover in which, from among the first cover 73 and the second cover 74, the first cover 73 is fixed, and the second cover 74 is slid is shown. The sliding cover 72 may be a double sliding cover in which both the first cover 73 and the second cover 74 are slid.

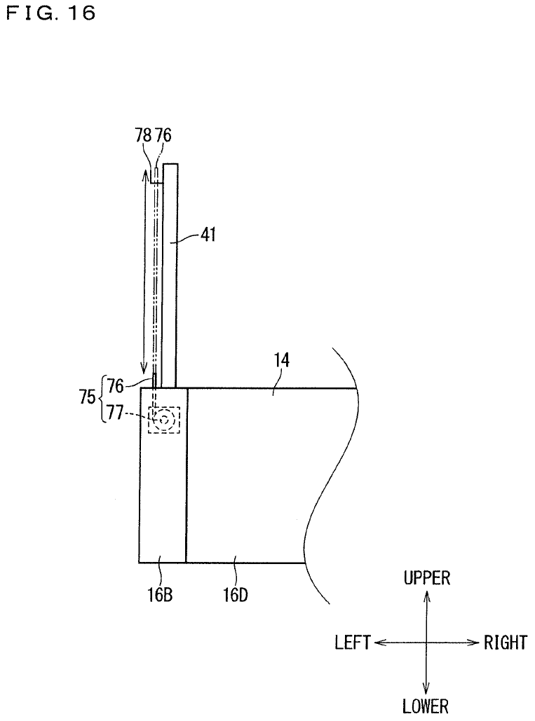

In an example illustrated in FIG. 16, a roller shade cover 75 is provided as the cargo bed cover. In the example illustrated in FIG. 16, the roller shade cover 75 is the vertical cover 67 that covers the side of the cargo bed 14. The roller shade cover 75 includes a shade 76 and a wind-up device 77. The shade 76 is wound and received by the wind-up device 77 as indicated by a solid line in FIG. 16. The shade 76 is extendable from the wind-up device 77 as indicated by an alternate long and two short dashes line in FIG. 16. The hook 78 catches a leading end of the extended shade 76 and holds the shade 76 in an extended state.

In the example illustrated in FIG. 16, the wind-up device 77 is provided at the bottom, and the hook 78 is provided at the top. The wind-up device 77 may be provided at the top. In this case, the hook 78 may be omitted if the shade 76 in the extended state can be maintained in the extended state by its own weight and the like. In the example illustrated in FIG. 16, the wind-up device 77 is received in the peripheral wall 16. The wind-up device 77 may be located outside the peripheral wall 16.

The accordion cover 70 illustrated in FIG. 14 and the sliding cover 72 illustrated in FIG. 15 may be provided to cover the side of the cargo bed 14. The roller shade cover 75 illustrated in FIG. 16 may be provided to cover the top of the cargo bed 14.

### <Trailer>

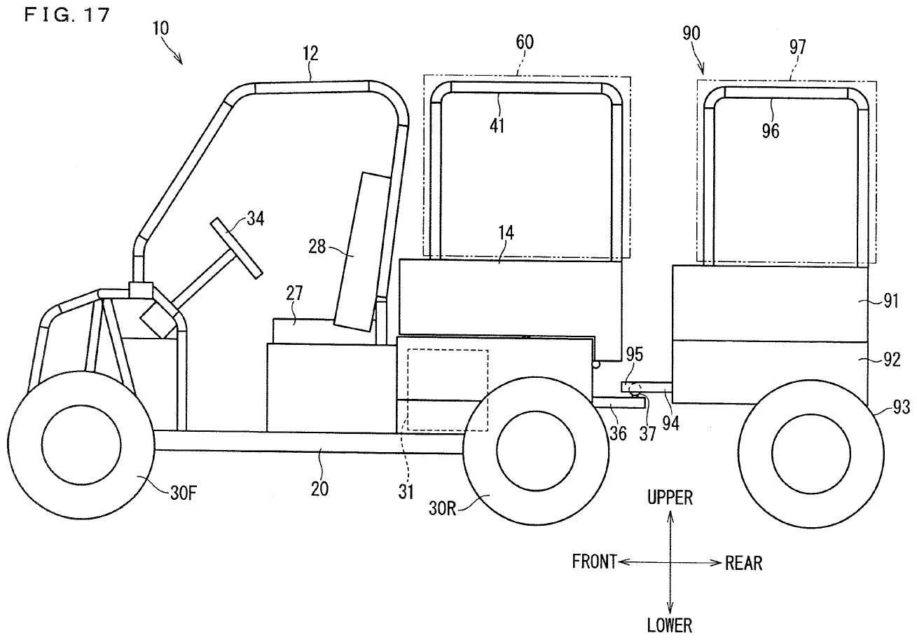

FIG. 17 is a side view illustrating the utility vehicle 10 and a trailer 90.

As illustrated in FIG. 17, the utility vehicle 10 may tow the trailer 90. The trailer 90 includes a cargo bed 91, support frames 96, and a towed part 94. In an example illustrated in FIG. 17, the trailer 90 includes a chassis 92 that supports the cargo bed 91 and wheels 93 that are pivotally supported by the chassis 92. In the example illustrated in FIG. 17, the wheels 93 are a pair of wheels but may be three or more wheels.

The support frames 96 are provided to the cargo bed 91 of the trailer 90. The above-mentioned configuration of the cargo bed 14 and the support frames 41 of the utility vehicle 10 is applicable to a configuration of the cargo bed 91 and the support frames 96 as appropriate. A cargo bed cover 97 is provided to the support frames 96. The above-mentioned configuration of the support frames 41 and the cargo bed cover 60 of the utility vehicle 10 is applicable to a configuration of the support frames 96 and the cargo bed cover 97 as appropriate.

The towed part 94 is a part towed by the utility vehicle 10. The towed part 94 is provided to a front portion of the chassis 20, for example. The utility vehicle 10 includes a towing part 36 to tow the trailer 90. A configuration of the towing part 36 and the towed part 94 is not particularly limited and can be set as appropriate. In the example illustrated in FIG. 17, the towing part 36 includes a hitch ball 37, and the towed part 94 includes a coupler 95 fitted to the hitch ball 37. The coupler 95 is fitted to the hitch ball 37, so that the towing part 36 and the towed part 94 are connected to be rotatable around numerous axes including an axis along the vertical direction, an axis along the left-right direction, and an axis along the front-rear direction.

In the example illustrated in FIG. 17, the utility vehicle 10 also includes the cargo bed 14 and the support frames 41. A configuration in which the utility vehicle 10 and the trailer 90 can support the support frames 41 and the support frames 96 having the same shape may be used. That is to say, the trailer 90 may be able to support the support frames 96 having the same shape as the support frames 41 provided to the utility vehicle 10. Costs for development of the support frames 41 and the support frames 96 can thus be reduced. In a case where the utility vehicle 10 and the trailer 90 include only the support frames 41 or the support frames 96, the support frames 41 or the support frames 96 can be attached to both the cargo bed 14 of the utility vehicle 10 and the cargo bed 91 of the trailer 90. In a case where the cargo bed 91 is provided to the trailer 90, the cargo bed 14 may not be provided to the utility vehicle 10.

### <Cargo Bed>

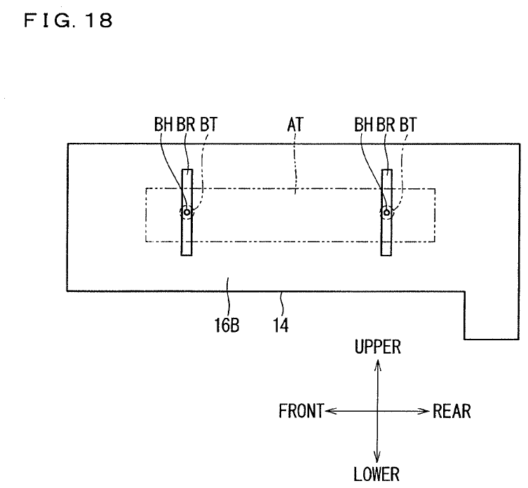

FIG. 18 is a side view illustrating the cargo bed 14.

As illustrated in FIG. 18, brackets BR may be provided to the cargo bed 14. The brackets BR may be used to attach an attachment AT, for example. The shape, the position, and the like of each of the brackets BR are not particularly limited and can be set as appropriate. For example, in an example illustrated in FIG. 18, the brackets BR are each formed to have a plate-like shape, and opposite ends of each of the brackets BR are fixed to a side surface of the peripheral wall 16 of the cargo bed 14. For example, the brackets BR may be provided to the left wall 16B and the right wall 16C. The brackets BR may be provided to the front wall 16A or the rear wall 16D. In the example illustrated in FIG. 18, each of the brackets BR extends vertically. Each of the brackets BR may extend horizontally (in the front-rear direction or the left-right direction). In the example illustrated in FIG. 18, two brackets BR are provided to one side surface. The number of brackets BR provided to one side surface may be one and may be three or more.

In the example illustrated in FIG. 18, fastening using a fastening member, such as a bolt BT, is used as a method of fixing the attachment AT to the brackets BR. Specifically, a fastening hole BH is formed in the middle in a longitudinal direction of each of the brackets BR. The fastening member can be fastened to the fastening hole BH. The attachment AT is fixed to the brackets BR via fastening members. A structure to fix the attachment AT to the brackets BR is not limited to a structure using the fastening members and can be set as appropriate.

The type of the attachment AT attached to the brackets BR is not particularly limited and can be set as appropriate. The attachment AT may be a ladder, a fuel tank, a water tank, or a storage, for example.

### <Effects and Others>

According to the utility vehicle 10 having a configuration as described above, the utility vehicle 10 includes the support frames 41 to support the cargo bed cover 60, so that the cargo bed cover 60 is easily attachable to the utility vehicle 10 via the support frames 41. In a case where the utility vehicle 10 includes the cargo bed cover 60 supported by the support frames 41, the cargo bed cover 60 can cover the cargo bed 14.

In a case where the utility vehicle 10 includes the dumper 22, and the support frames 41 are supported by the cargo bed 14 as illustrated in FIG. 3, the support frames 41 can be tilted together with the cargo bed 14 when the cargo bed 14 is dumped to suppress interference of the cargo bed 14 or the cargo with the support frames 41.

In a case where the support frames 41 are removably supported as illustrated in FIG. 4, the support frames 41 can be removed as necessary.

In a case where the support frames 41 are provided to the cargo bed 14 as illustrated in FIG. 4, there is no need to provide a structure to support the support frames 41 at a position other than the cargo bed 14.

In a case where the lower end of each of the support columns 42 of the support frames 41 is inserted into a corresponding one of the holes 18 of the cargo bed 14 and supported as illustrated in FIG. 4, the support frames 41 can easily be supported by the cargo bed 14.

In a case where the support frames 41 each include the cover support 46 that supports the cargo bed cover 60, and the cover support 46 is vertically displaceable as illustrated in FIG. 5, an attachment position of the cargo bed cover 60 can be changed along the vertical direction as necessary.

In a case where the utility vehicle 10 includes the lock 50 that locks each of the support frames 41 to the ROPS 12 as illustrated in FIG. 6, rattling of the support frames 41 can be suppressed.

In a case where the lock 50 locks the support frames 41 to a rear portion of the ROPS 12 as illustrated in FIG. 6, the support frames 41 are locked to the ROPS 12 at a position close to the support frames 41.

In a case where the cargo bed cover includes one or more flap covers 64, 65, 66 that are flappably supported by the support frames 41 as illustrated in FIGS. 8 to 11, the flap covers can be caused to flap to open and close the covers and change a state of the covers.

In a case where the flap covers include the side flap covers 64 that are rotatable around the axes along the front-rear direction as illustrated in FIG. 9, the covers on the sides of the cargo bed 14 can be caused to flap.

In a case where the support frames 41 include the first support that supports the side flap covers 64 in the first state in which the sides of the cargo bed 14 are open and the second support that supports the side flap covers 64 in the second state in which the sides of the cargo bed 14 are covered as illustrated in FIG. 9, the side flap covers 64 can be side walls of the cargo bed 14.

In a case where the first support supports the side flap covers 64 in a state in which the side flap covers 64 cover the top of the cargo bed 14 as illustrated in FIG. 9, the side flap covers 64 can be the roof for the cargo bed 14.

In a case where the flap covers include the rear flap cover 65, 66 that covers the rear of the cargo bed 14 and flaps around the axis along the vehicle width direction or the vertical direction as illustrated in FIGS. 10 and 11, the cover rearward of the cargo bed 14 can be caused to flap.

In a case where the cargo bed cover 60 includes the vertical cover 67 that covers the side or the rear of the cargo bed 14, and the vertical cover 67 includes the window 68 as illustrated in FIG. 12, the inside of the cargo bed cover 60 is visible and the cargo on the cargo bed 14 is loadable and unloadable through the window 68.

In a case where the cargo bed cover 69 is removably attachable to the support frames 41 as illustrated in FIG. 13, the cargo bed cover 69 can be removed from the support frames 41 as necessary.

In a case where the cargo bed cover 72 is changeable between the cover state and the top opening state as illustrated in FIGS. 14 and 15, the top of the cargo bed 14 can be opened and closed by operating the cargo bed cover 72 as necessary.

In a case where the cargo bed cover 60 includes the cover main body 61 that includes the opening and the door 63 that blocks the opening of the cover main body 61 so that the opening is openable and closable as illustrated in FIG. 2, the opening of the cargo bed cover 60 can be opened and closed as necessary.

In a case where the support frames 41 are provided to the trailer 90 towed by the utility vehicle 10 as illustrated in FIG. 17, the support frames 41 can easily be provided to the trailer 90 instead of being provided to the utility vehicle 10.

Configurations described in the above-mentioned embodiment and modifications can be combined with each other as appropriate unless any contradiction occurs.

### <Appendices>

The present application discloses the following aspects.

A first aspect is a utility vehicle comprising: a rollover protective structure (ROPS) that defines a riding space: a cargo bed that is located rearward of the ROPS: and a support frame to support a cargo bed cover that covers the cargo bed. According to the utility vehicle, the cargo bed cover is easily attachable to the utility vehicle via the support frame.

A second aspect is the utility vehicle according to the first aspect further comprising: a chassis that supports the cargo bed: and a dumper that tilts the cargo bed relative to the chassis, wherein the support frame is supported by the cargo bed. The support frame can thus be tilted together with the cargo bed when the cargo bed is dumped to suppress interference of the cargo bed or cargo with the support frame.

A third aspect is the utility vehicle according to the first or the second aspect, wherein the support frame includes a cover support that supports the cargo bed cover, and the cover support is vertically displaceable. An attachment position of the cargo bed cover can thus be changed along a vertical direction as necessary.

A fourth aspect is the utility vehicle according to any one of the first to the third aspects further comprising a lock that locks the support frame to the ROPS. Rattling of the support frame can thus be suppressed.

A fifth aspect is the utility vehicle according to the fourth aspect, wherein the lock locks the support frame to a rear portion of the ROPS. The support frame is thus locked to the ROPS at a position close to the support frame.

A sixth aspect is the utility vehicle according to any one of the first to the fifth aspects, wherein the support frame is removably supported. The support frame can thus be removed as necessary.

A seventh aspect is the utility vehicle according to the sixth aspect, wherein the support frame is provided to the cargo bed. Thus, there is no need to provide a structure to support the support frame at a position other than the cargo bed.

An eighth aspect is the utility vehicle according to the seventh aspect, wherein the cargo bed includes upward opening holes, the support frame includes vertically extending support columns, and a lower end of each of the support columns is inserted into a corresponding one of the holes and supported. The support frame can thus easily be supported by the cargo bed.

A ninth aspect is the utility vehicle according to any one of the first to the eighth aspects further comprising the cargo bed cover that is supported by the support frame. The cargo bed cover can thus cover the cargo bed.

A tenth aspect is the utility vehicle according to the ninth aspect, wherein the cargo bed cover includes a flap cover that is flappably supported by the support frame. The flap cover can be caused to flap to open and close the cover and change a state of the cover.

An eleventh aspect is the utility vehicle according to the tenth aspect, wherein the flap cover includes a side flap cover that is rotatable around an axis along a front-rear direction. The cover on a side of the cargo bed can thus be caused to flap.

A twelfth aspect is the utility vehicle according to the eleventh aspect, wherein the support frame includes a first support that supports the side flap cover in a first state in which a side of the cargo bed is open and a second support that supports the side flap cover in a second state in which the side of the cargo bed is covered. The side flap cover can thus be a side wall of the cargo bed.

A thirteenth aspect is the utility vehicle according to the twelfth aspect, wherein the first support supports the side flap cover in a state in which the side flap cover covers a top of the cargo bed. The side flap cover can thus be a roof for the cargo bed.

A fourteenth aspect is the utility vehicle according to the tenth aspect, wherein the flap cover includes a rear flap cover that covers a rear of the cargo bed and flaps around an axis along a vehicle width direction or a vertical direction. The cover rearward of the cargo bed can thus be caused to flap.

A fifteenth aspect is the utility vehicle according to the ninth aspect, wherein the cargo bed cover includes a vertical cover that covers a side or a rear of the cargo bed, and the vertical cover includes a window. Thus, the inside of the cargo bed cover is visible and the cargo on the cargo bed is loadable and unloadable through the window.

A sixteenth aspect is the utility vehicle according to the ninth aspect, wherein the cargo bed cover is removably attachable to the support frame. The cargo bed cover can thus be removed from the support frame as necessary.

A seventeenth aspect is the utility vehicle according to the ninth aspect, wherein the cargo bed cover is changeable between a cover state and a top opening state while being attached to the support frame, the cover state being a state in which the cargo bed cover covers a top of the cargo bed, the top opening state being a state in which the cargo bed cover covers a smaller range of the top of the cargo bed than in the cover state. The top of the cargo bed can thus be opened and closed by operating the cargo bed cover as necessary.

An eighteenth aspect is the utility vehicle according to the ninth aspect, wherein the cargo bed cover includes a cover main body that includes an opening and a door that blocks the opening of the cover main body so that the opening is openable and closable. The opening of the cargo bed cover can thus be opened and closed as necessary.

A nineteenth aspect is a trailer towed by a utility vehicle including a rollover protective structure (ROPS) that defines a riding space, the trailer comprising: a cargo bed: a support frame to support a cargo bed cover that covers the cargo bed; and a towed part that is towed by the utility vehicle. According to the trailer, the support frame can be provided to the trailer instead of being provided to the utility vehicle.

A twentieth aspect is a cargo bed cover structure for a utility vehicle including a rollover protective structure (ROPS) that defines a riding space and a cargo bed that is located rearward of the ROPS, the cargo bed cover structure comprising: a support frame that is attachable to the utility vehicle: and a cargo bed cover that is supported by the support frame and covers the cargo bed. According to the cargo bed cover structure, the cargo bed cover is easily attachable to the utility vehicle.

The foregoing description is in all aspects illustrative and not restrictive. It is therefore understood that numerous unillustrated modifications can be devised without departing from the scope of the invention.

What is claimed is:

1. A utility vehicle comprising:
a rollover protective structure (ROPS) that defines a riding space;
a cargo bed that is located rearward of the ROPS; and
a support frame to support a cargo bed cover that covers the cargo bed.

2. The utility vehicle according to claim 1 further comprising:
a chassis that supports the cargo bed; and
a dumper that tilts the cargo bed relative to the chassis, wherein
the support frame is supported by the cargo bed.

3. The utility vehicle according to claim 1, wherein
the support frame includes a cover support that supports the cargo bed cover, and
the cover support is vertically displaceable.

4. The utility vehicle according to claim 1 further comprising
a lock that locks the support frame to the ROPS.

5. The utility vehicle according to claim 4, wherein
the lock locks the support frame to a rear portion of the ROPS.

6. The utility vehicle according to claim 1, wherein
the support frame is removably supported.

7. The utility vehicle according to claim 1, wherein
the support frame is provided to the cargo bed.

8. The utility vehicle according to claim 7, wherein
the cargo bed includes upward opening holes,
the support frame includes vertically extending support columns, and
a lower end of each of the support columns is inserted into a corresponding one of the holes and supported.

9. The utility vehicle according to claim 1 further comprising
the cargo bed cover that is supported by the support frame.

10. The utility vehicle according to claim 9, wherein
the cargo bed cover includes a flap cover that is flappably supported by the support frame.

11. The utility vehicle according to claim 10, wherein
the flap cover includes a side flap cover that is rotatable around an axis along a front-rear direction.

12. The utility vehicle according to claim 11, wherein
the support frame includes a first support that supports the side flap cover in a first state in which a side of the cargo bed is open and a second support that supports the side flap cover in a second state in which the side of the cargo bed is covered.

13. The utility vehicle according to claim 12, wherein
the first support supports the side flap cover in a state in which the side flap cover covers a top of the cargo bed.

14. The utility vehicle according to claim 10, wherein
the flap cover includes a rear flap cover that covers a rear of the cargo bed and flaps around an axis along a vehicle width direction or a vertical direction.

15. The utility vehicle according to claim 9, wherein
the cargo bed cover includes a vertical cover that covers a side or a rear of the cargo bed, and
the vertical cover includes a window.

16. The utility vehicle according to claim 9, wherein
the cargo bed cover is removably attachable to the support frame.

17. The utility vehicle according to claim 9, wherein
the cargo bed cover is changeable between a cover state and a top opening state while being attached to the support frame, the cover state being a state in which the cargo bed cover covers a top of the cargo bed, the top opening state being a state in which the cargo bed cover covers a smaller range of the top of the cargo bed than in the cover state.

18. The utility vehicle according to claim 9, wherein
the cargo bed cover includes a cover main body that includes an opening and a door that blocks the opening of the cover main body so that the opening is openable and closable.

19. A trailer towed by a utility vehicle including a rollover protective structure (ROPS) that defines a riding space, the trailer comprising:
a cargo bed;
a support frame to support a cargo bed cover that covers the cargo bed; and
a towed part that is towed by the utility vehicle.

20. A cargo bed cover structure for a utility vehicle including a rollover protective structure (ROPS) that defines a riding space and a cargo bed that is located rearward of the ROPS, the cargo bed cover structure comprising:
a support frame that is attachable to the utility vehicle; and
a cargo bed cover that is supported by the support frame and covers the cargo bed.
